(19) United States
(12) Patent Application Publication
(10) Pub. No.: US 2025/0183444 A1
(43) Pub. Date: Jun. 5, 2025

(54) BATTERY CASE FOR ELECTRIC VEHICLE, AND METHOD FOR MANUFACTURING SAME

(71) Applicants: Kabushiki Kaisha Kobe Seiko Sho (Kobe Steel, Ltd.), Kobe-shi (JP); TOYOTA JIDOSHA KABUSHIKI KAISHA, Toyota-shi (JP)

(72) Inventors: Hideki ISHITOBI, Shimonoseki-shi (JP); Kouichi DAIGAKU, Okazaki-shi (JP)

(73) Assignees: Kabushiki Kaisha Kobe Seiko Sho (Kobe Steel, Ltd.), Kobe-shi (JP); TOYOTA JIDOSHA KABUSHIKI KAISHA, Toyota-shi (JP)

(21) Appl. No.: 18/843,763

(22) PCT Filed: Mar. 8, 2023
(86) PCT No.: PCT/JP2023/008870

§ 371 Date: Sep. 4, 2024

(30) Foreign Application Priority Data
Mar. 9, 2022 (JP) 2022-036045

(51) Int. Cl. H01M 50/242; B60L 50/64; H01M 50/249; H01M 50/262; H01M 50/289

(52) U.S. Cl. CPC H01M 50/242; B60L 50/64; H01M 50/249; H01M 50/262; H01M 50/289; H01M 2220/20

(57) ABSTRACT

An electric vehicle battery case includes: a frame including a plurality of framework members and joined through a joining member, the frame formed in a polygonal frame shape when viewed from a vehicle vertical direction, the frame configured to define a through hole inside; and a tray configured to house a battery, the tray disposed at least partially in the through hole of the frame. The plurality of framework members and include a first framework member and a second framework member which are made of an aluminum extruded material. In the frame, the first framework member and the joining member are joined by a mechanical joining method, and the second framework member and the joining member are joined by a mechanical joining method, which leads to the first framework member and the second framework member being indirectly joined through the joining member.

### TECHNICAL FIELD

The present disclosure relates to an electric vehicle battery case and a method for manufacturing the same.

### BACKGROUND ART

An electric vehicle such as an electric car needs to mount a large capacity battery in order to secure a sufficient cruising distance, and on the other hand, the electric vehicle is required to include a wide vehicle interior. In order to satisfy both these requirements, in many electric cars, a large-capacity battery is housed in a battery case and mounted on the entire underfloor surface of the vehicle. Therefore, the electric vehicle battery case is required to have high sealing performance for preventing water from entering from a road surface or the like to prevent malfunctions of electronic components, and high collision strength is required to protect the internal battery.

For example, Patent Document 1 discloses a battery case in which sealing performance is improved by using a tray obtained by forming a metal plate into a bathtub shape by cold press forming.

### PRIOR ART DOCUMENT

### Patent Document

Patent Document 1: JP 2017-226353 A

### SUMMARY OF THE INVENTION

### Problems to be Solved by the Invention

In the battery case of Patent Document 1, the sealing performance is improved by a bathtub-shaped tray, but in order to form a frame for housing the tray, it is necessary to join the longitudinal frame, the front beam, and the rear beam by joining means such as welding. In particular, when welding is used as the joining means, not only the manufacturing step becomes complicated but also thermal damage may occur.

An object of the present disclosure is, in an electric vehicle battery case and a method for manufacturing the same, to improve sealing performance by a bathtub-shaped tray, and to simply configure a frame for housing the tray without thermal damage.

### Solutions to the Problems

A first aspect of the present disclosure provides an electric vehicle battery case including: a frame including a plurality of framework members joined through a joining member, the frame formed in a polygonal frame shape when viewed from a vehicle vertical direction, the frame configured to define a space inside; and a tray having a bathtub shape configured to house a battery, the tray disposed at least partially in the space of the frame. The plurality of framework members includes a first framework member and a second framework member which are made of an aluminum extruded material. In the frame, the first framework member and the joining member are joined by a mechanical joining method, and the second framework member and the joining member are joined by a mechanical joining method, which leads to the first framework member and the second framework member being indirectly joined through the joining member.

According to this configuration, since the first framework member and the second framework member are indirectly joined through the joining member by the mechanical joining method, complicated welding is not required. Here, the mechanical joining method is a joining method using mechanical energy, unlike a metallurgical joining method such as welding. The mechanical joining method includes, for example, a joining method using a bolt, a nut, a rivet, or the like. In addition, the above indirect joining means that the first framework member and the second framework member are joined through a joining member without being directly joined to each other. Therefore, since a joining method using heat such as welding is not used, thermal damage to the frame can be suppressed, and the frame can be simply configured. Furthermore, since the first framework member and the second framework member are joined through the joining member, it is possible to prevent the joint portion from being deformed by an external force and to improve the rigidity of the entire battery case. In addition, since the tray is formed in a bathtub shape, there is no joint in the tray, and high sealing performance capable of preventing water from entering from a road surface or the like can be secured.

The mechanical joining method may include flow drill screw joining.

According to this configuration, it is possible to be coupled from one side without a pilot hole, and to constitute the frame easily. Here, the flow drill screw joining is a method in which a member is penetrated by rotating a screw having a sharp tip at a high speed, and the rotation speed is gradually lowered to fix the screw, and the two members are fastened. Unlike welding, flow drill screw joining has the advantage that the joining of dissimilar materials can be easily implemented.

The tray may be brought into pressure contact with the frame.

According to this configuration, the frame and the tray can be easily integrated without requiring welding.

A negative angle portion in which a negative angle directed at least partially inward in a horizontal direction from a bottom wall of the tray toward an upper side in the vehicle vertical direction is formed may be provided.

According to this configuration, even when an upward force is applied to the tray, the negative angle portion is caught by the frame, so that the tray can be prevented from being detached from the frame. That is, the pressure contact between the tray and the frame can be prevented from being released.

The joining member may have a curved surface that forms the inner corner portion of the frame into a curved shape when viewed from the vehicle vertical direction.

According to this configuration, at the time of the pressure contact, the tray is pressed against the curved surface, at the inner corner portion of the frame. If the inner corner portion is at a right angle, there is a risk that the corner portion of the tray tends to be deformed into a right angle, and stress is concentrated thereon to cause cracking. However, since the inner corner portion is the curved surface as in the above configuration, the corner portion of the tray is supported by the curved surface at the time of the pressure contact, so the concentration of stress on the corner portion of the tray can be suppressed, and cracking of the tray can be suppressed. Here, the curved shape may be, for example, a circular arc shape.

The joining member may include an upper member disposed at a relatively upper position and a lower member disposed at a relatively lower position in the vehicle vertical direction. The lower member may be joined to the first framework member and the second framework member by the mechanical joining method. The upper member may be fitted and fixed to the lower member.

According to this configuration, since the joining member is vertically divided, the degree of freedom in design when manufacturing the joining member is improved.

The upper member may include a flange portion that supports each of outer surfaces of the first framework member and the second framework member constituting an outer surface of the frame when viewed from the vehicle vertical direction.

According to this configuration, since the first framework member and the second framework member are supported by the flange portion, deformation of the joint portion can be suppressed.

A second aspect of the present disclosure provides a method for manufacturing an electric vehicle battery case, the method including: preparing a member to be formed having a flat-plate shape, a plurality of framework members, and a joining member, the plurality of framework members including a first framework member and a second framework member which are made of an aluminum extruded material; indirectly joining the first framework member and the second framework member through the joining member by joining the first framework member and the joining member by a mechanical joining method and by joining the second framework member and the joining member by a mechanical joining method to form a frame having a polygonal frame shape when viewed from a vehicle vertical direction and defining a space inside; superposing and disposing the member to be formed on the frame; and applying pressure to the member to be formed from a side opposite to that of the frame, pressing the member to be formed against the frame, swelling the member to be formed in the space, resulting in deforming the member to be formed into a tray having a bathtub shape and bringing the member to be formed into pressure contact with the frame.

According to this method, since the first framework member and the second framework member are indirectly joined through the joining member by the mechanical joining method, complicated welding is not required. Therefore, thermal damage to the frame can be suppressed, and the frame can be simply configured. Furthermore, since the first framework member and the second framework member are joined through the joining member, it is possible to prevent the joint portion from being deformed by an external force and to improve the rigidity of the entire battery case. In addition, since the tray is formed in a bathtub shape, there is no joint in the tray, and high sealing performance capable of preventing water from entering from a road surface or the like can be secured. In addition, by the pressure contact, the frame and the tray can be easily integrated without requiring welding. At this time, the manufacturing step can be simplified by simultaneously performing the forming of the bathtub-shaped tray and the pressure contact between the tray and the frame.

### Effects of the Invention

According to the present disclosure, in an electric vehicle battery case and a method for manufacturing the same, it is possible to improve sealing performance by a bathtub-shaped tray, and to simply configure a frame for housing the tray without thermal damage.

### BRIEF DESCRIPTION OF DRAWINGS

FIG. 1 is a side view of an electric car mounting an electric vehicle battery case according to a first embodiment of the present disclosure;

FIG. 2 is a schematic cross-sectional view of the battery case;

FIG. 3 is a perspective view of the battery case;

FIG. 4 is an exploded perspective view of the battery case;

FIG. 5 is an exploded perspective view of a frame;

FIG. 6 is a plan view of a tray;

FIG. 7 is a perspective view of a member to be formed, a first framework member, a second framework member, and a joining member;

FIG. 8 is a first cross-sectional view showing a method for manufacturing the battery case;

FIG. 9 is a second cross-sectional view showing a method for manufacturing the battery case;

FIG. 10 is a third cross-sectional view showing a method for manufacturing the battery case;

FIG. 11 is a fourth cross-sectional view showing a method for manufacturing the battery case;

FIG. 12 is a cross-sectional view showing a first modification of negative angle forming;

FIG. 13 is a cross-sectional view showing a second modification of negative angle forming;

FIG. 14 is a schematic cross-sectional view of a battery case showing a modification of the closing plate;

FIG. 15 is an exploded perspective view showing a first modification of the frame;

FIG. 16 is a perspective view showing a second modification of the frame;

FIG. 17 is an exploded perspective view showing a second modification of the frame;

FIG. 18 is a perspective view of a frame of a battery case according to a second embodiment;

FIG. 19 is an exploded perspective view of a frame;

FIG. 20 is an exploded perspective view showing a first modification of the joining member;

FIG. 21 is a perspective view showing a second modification of the joining member.

FIG. 22 is an exploded perspective view showing a second modification of the joining member;

FIG. 23 is a perspective view showing a third modification of the joining member;

FIG. 24 is an exploded perspective view showing a third modification of the joining member; and

FIG. 25 is a perspective view showing a modification of the frame and the cross member.

### DETAILED DESCRIPTION

Hereinafter, embodiments of the present disclosure will be described with reference to the accompanying drawings.

### First Embodiment

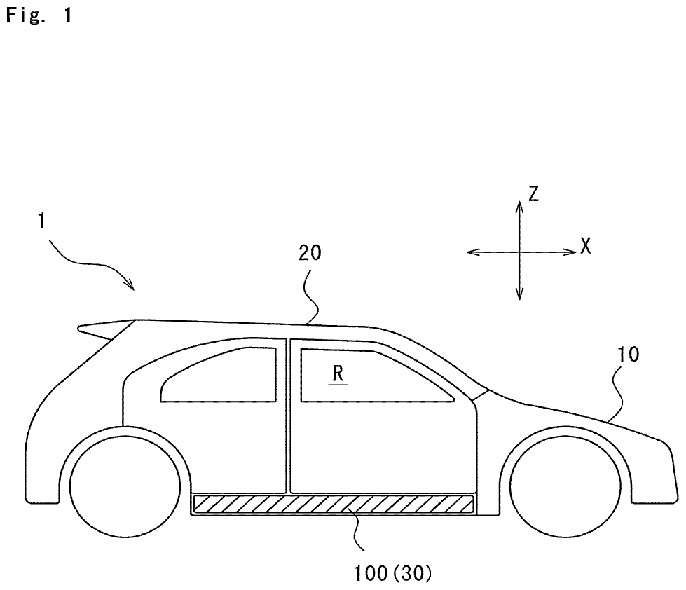

Referring to FIG. 1, an electric vehicle 1 is a vehicle that travels by driving a motor (not shown) by electric power supplied from a battery 30. For example, the electric vehicle 1 may be an electric car, a plug-in hybrid vehicle, or the like. The type of the vehicle is not particularly limited, and may be a passenger car, a truck, a maintenance vehicle, other mobility, or the like. Hereinafter, a case of a passenger car type electric vehicle as the electric vehicle 1 will be taken as an example to be described.

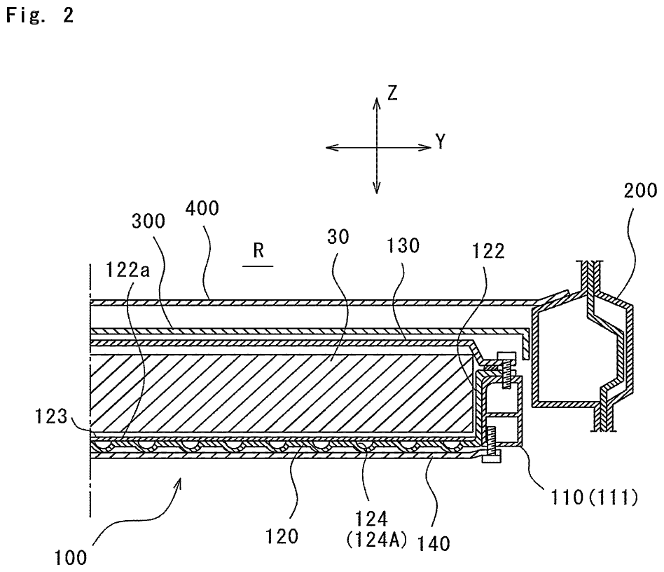

The electric vehicle 1 mounts a motor, a high-voltage apparatus, and the like (not shown) in the vehicle body front portion 10. In addition, the electric vehicle 1 mounts an electric vehicle battery case 100 (hereinafter, also simply referred to as a battery case 100) in which a battery 30 is housed in substantially the entire underfloor space of the vehicle interior R of the vehicle body central portion 20. It should be noted that in FIG. 1, the front-rear direction of the electric vehicle 1 is represented by the X direction, and the vertical direction is represented by the Z direction. The same notation also applies to the following drawings, and the vehicle width direction is represented by the Y direction in FIG. 2 and subsequent figures.

Referring to FIG. 2, the battery case 100 is disposed inside the rocker member 200 in the vehicle width direction. The rocker member 200 extends in the vehicle front-rear direction at both lower ends in the vehicle width direction of the electric vehicle 1 (see FIG. 1). The rocker member 200 is formed by bonding a plurality of metal plates, and has a function of protecting the vehicle interior R and the battery case 100 against impact from the side of the electric vehicle 1.

Referring also to FIGS. 2 to 4, the battery case 100 includes a frame 110 defining a through hole TH, a tray 120 having a bathtub shape, a top cover 130 (see FIG. 2) and an under cover 140 (see FIG. 2) arranged so as to sandwich them from above and below, and a closing plate 123 arranged on a bottom wall 122a of the tray 120. Here, the through hole TH is an example of a space in the present disclosure.

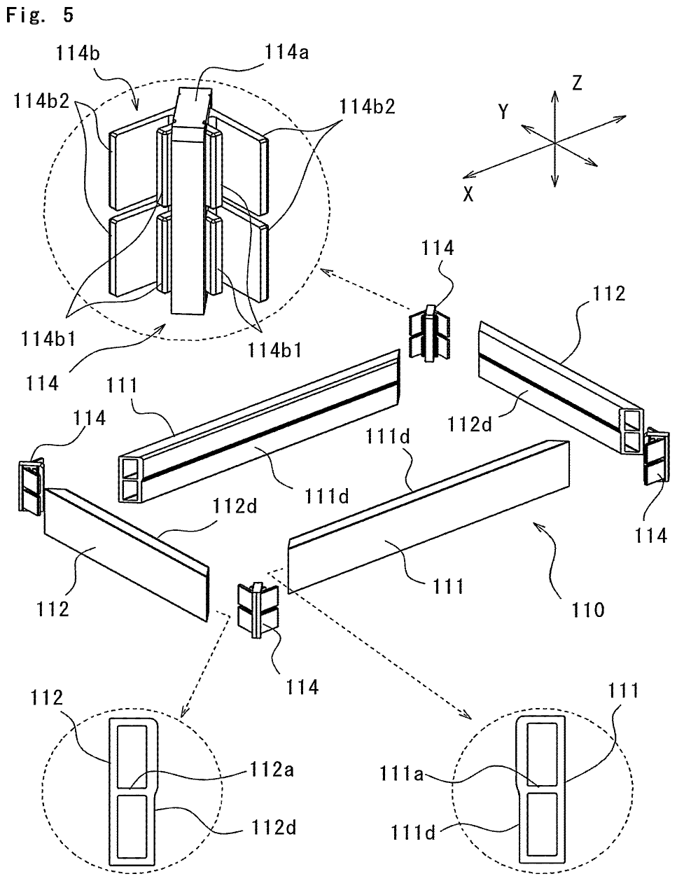

Referring also to FIG. 5, the frame 110 is a member forming the framework of the battery case 100. The frame 110 is formed in a polygonal frame shape (rectangular frame shape in the present embodiment) when viewed from the vehicle vertical direction by joining the plurality of framework members 111 and 112 through the joining member 114, and defines the through hole TH inside. Hereinafter, the inside of the frame 110 refers to the center side of the rectangular frame shape, and the outside refers to the opposite side. The plurality of framework members 111 and 112 include two first framework members 111 and two second framework members 112.

The first framework member 111 is made of an aluminum extruded material linearly extending in the vehicle front-rear direction. The first framework member 111 has rigidity as a substantially rigid body. The first framework member 111 has a hollow shape. The inside of the first framework member 111 is partitioned in the vehicle vertical direction by a partition wall 111a. The first framework member 111 has a step surface 111d on the inside in the vehicle width direction in a cross section perpendicular to the vehicle front-rear direction. The step surface 111d has a step shape so as to narrow the through hole TH on the upper side in the vehicle vertical direction (see the inside of the lower right broken line circle in FIG. 5).

In addition, the first framework member 111 is cut obliquely from the vehicle width direction at both end portions in the vehicle front-rear direction when viewed from the vehicle vertical direction. The both end portions are joined to the second framework member 112 through the joining member 114.

The second framework member 112 is made of an aluminum extruded material linearly extending in the vehicle width direction. The second framework member 112 has rigidity as a substantially rigid body. The second framework member 112 has a hollow shape. The inside of the second framework member 112 is partitioned in the vehicle vertical direction by a partition wall 112a. The second framework member 112 has a step surface 112d on the inside in the vehicle front-rear direction in a cross-section perpendicular to the vehicle front-rear direction. The step surface 112d has a step shape so as to narrow the through hole TH on the upper side in the vehicle vertical direction (see the inside of the lower left broken line circle in FIG. 5).

In addition, the second framework member 112 is cut obliquely from the vehicle front-rear direction at both end portions in the vehicle width direction when viewed from the vehicle vertical direction. The both end portions are joined to the first framework member 111 through the joining member 114.

The joining member 114 has a rectangular parallelepiped base portion 114a and a protruding portion 114b protruding from the base portion 114a. The protruding portion 114b includes four inner protruding pieces 114b1 and four outer protruding pieces 114b2 protruding more greatly from the base portion 114a than the four inner protruding pieces 114b1. When viewed from the vehicle vertical direction, the four outer protruding pieces 114b2 are positioned on the outside in the vehicle width direction or the outside in the vehicle front-rear direction of the four inner protruding pieces 114b1. The four inner protruding pieces 114b1 and the four outer protruding pieces 114b2 are inserted into the first framework member 111 and the second framework member 112. Therefore, when the first framework member 111, the second framework member 112, and the joining member 114 are assembled as the frame 110, only the base portion 114a of the joining member 114 can be visually recognized, and the four inner protruding pieces 114b1 and the four outer protruding pieces 114b2 cannot be visually recognized.

The first framework member 111 and the second framework member 112 are indirectly joined through the joining member 114 by a mechanical joining method. The mechanical joining method includes, for example, a joining method using a bolt, a nut, a rivet, or the like. In the present embodiment, the joining member 114 is joined to the first framework member 111 and the second framework member 112 by the flow drill screw in the four outer protruding pieces 114b2. The flow drill screw joining is an example of a mechanical joining method.

In the flow drill screw joining, an outer wall of the first framework member 111 and the four outer protruding pieces 114b2 of the joining member 114 are penetrated by rotating a screw (not shown) having a sharp tip at a high speed, and the rotation speed is gradually lowered to fix the screw, and these are fastened. Similarly, the outer wall of the second framework member 112 and the four outer protruding pieces 114b2 of the joining member 114 are penetrated by rotating a screw (not shown) having a sharp tip at a high speed, and the rotation speed is gradually lowered to fix the screw, and these are fastened. The flow drill screw joining can be coupled from one side without a pilot hole, and the frame 110 can be easily formed. In addition, unlike welding, there is an advantage that joining of dissimilar materials can be easily implemented. Therefore, even when the first framework member 111, the second framework member 112, and the joining member 114 are made of dissimilar materials, they can be easily joined.

It should be noted that in the present embodiment, the frame 110 defining the through hole TH will be described as an example, but the shape of the frame 110 is not limited to the through shape. For example, the frame 110 may have a recessed shape instead of the penetrating shape, that is, may have a bottom wall.

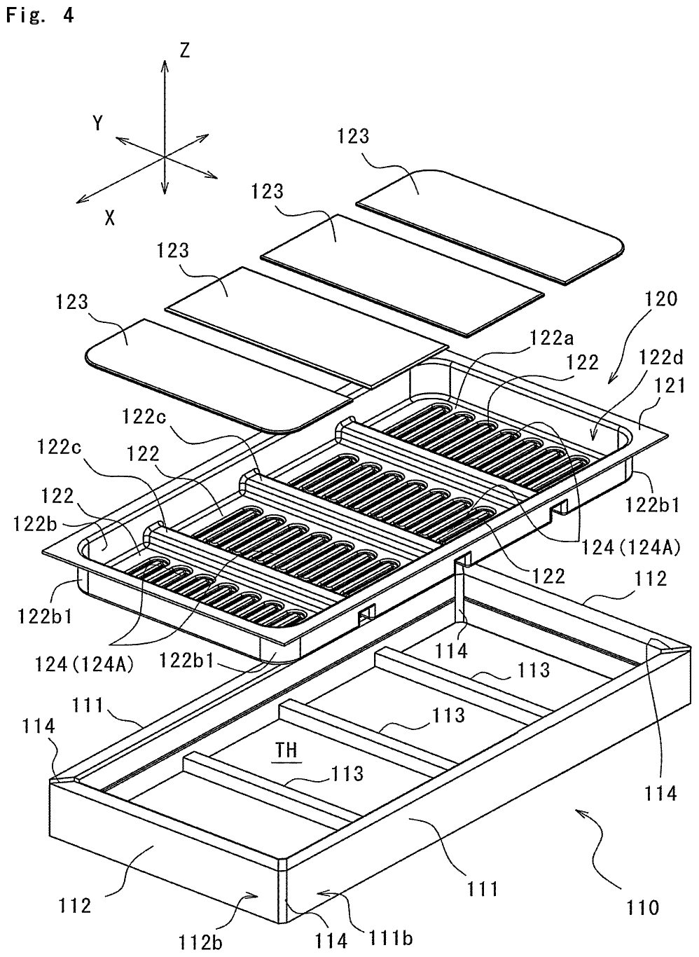

Referring again to FIG. 4, three cross members 113 are attached to the frame 110. The three cross members 113 are arranged at equal intervals in parallel with the two second framework members 112 so as to connect the two first framework members 111 in the through hole TH. The three cross members 113 have a function of improving the strength of the battery case 100. In particular, the three cross members 113 can improve strength against collision from the side of the electric vehicle 1 (see FIG. 1). It should be noted that the mode of the cross member 113 is not particularly limited, and the size, shape, arrangement, number, and the like thereof can be optionally set. In addition, the cross member 113 is not an essential configuration and may be omitted as necessary.

The tray 120 is a bathtub-shaped member that houses the battery 30. The tray 120 is made of, for example, an aluminum alloy plate material. The tray 120 includes a flange 121 extending in a horizontal direction (X-Y direction) at an outer edge portion, and a housing portion 122 being continuous with the flange 121 and having a recessed shape. The housing portion 122 is a portion that houses the battery 30 and is partially disposed in the through hole TH of the frame 110. The housing portion 122 has a bottom wall 122a constituting a bottom surface, and a peripheral wall 122b provided around the bottom wall 122a and defining an opening 122d on the opposite side from the bottom wall 122a. As will be described in detail below, the peripheral wall 122b is brought into pressure contact with the frame 110.

Three projecting portions 122c having shapes complementary to the three cross members 113 are formed on the bottom wall 122a of the housing portion 122. The three projecting portions 122c are portions where the bottom wall 122a partially projects upward and extends in the vehicle width direction. The bottom wall 122a is formed with grooves 124 through which the coolant flows in respective regions divided by the three projecting portions 122c. As will be described in detail below, the three projecting portions 122c are brought into pressure contact with the three cross members 113.

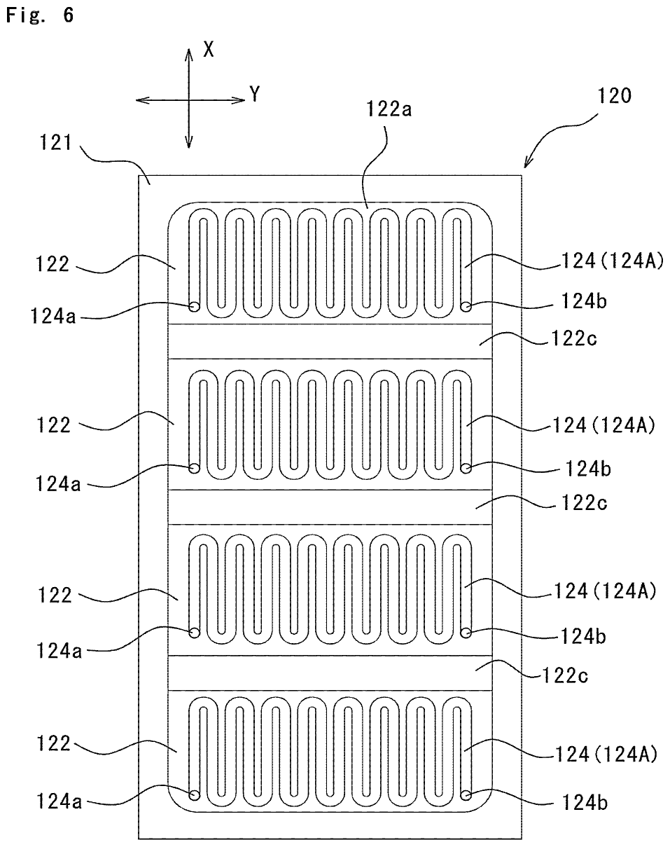

Referring to FIG. 6, the individual groove 124 is formed in a bellows shape in plan view. One end of the individual groove 124 is provided with an inlet 124a into which a coolant flows, and the other end is provided with an outlet 124b from which the coolant flows out. In addition, the cross-sectional shape of the groove 124 is semicircular (see FIG. 2). It should be noted that a plan view shape and a cross-sectional shape of the groove 124 are not particularly limited, and may be any shape.

Referring to FIGS. 2 and 4 together, in each region of the bottom wall 122a divided by the three projecting portions 122c, a closing plate 123 of a corresponding shape is arranged and joined from above. The groove 124 is closed with the closing plate 123, and a coolant flow path 124A through which the coolant flows is defined.

A battery 30 (see FIG. 2) is disposed on the closing plate 123. The coolant flowing through the coolant flow path 124A cools the battery 30 through the closing plate 123. The closing plate 123 may be an aluminum plate or the like of high thermal conductivity in order to improve cooling efficiency.

A joining method such as an adhesive or thermal fusion (for example, laser thermal fusion) may be used when the closing plate 123 is joined to the tray 120. Preferably, friction stir welding (FSW) is used. Since the FSW is joining in a solid phase state, unlike normal welding, the FSW does not cause a blowhole and is excellent in sealing performance. In order to improve the cooling performance, the thickness of the closing plate 123 may be, for example, 2 mm or less (for example, about 1 mm).

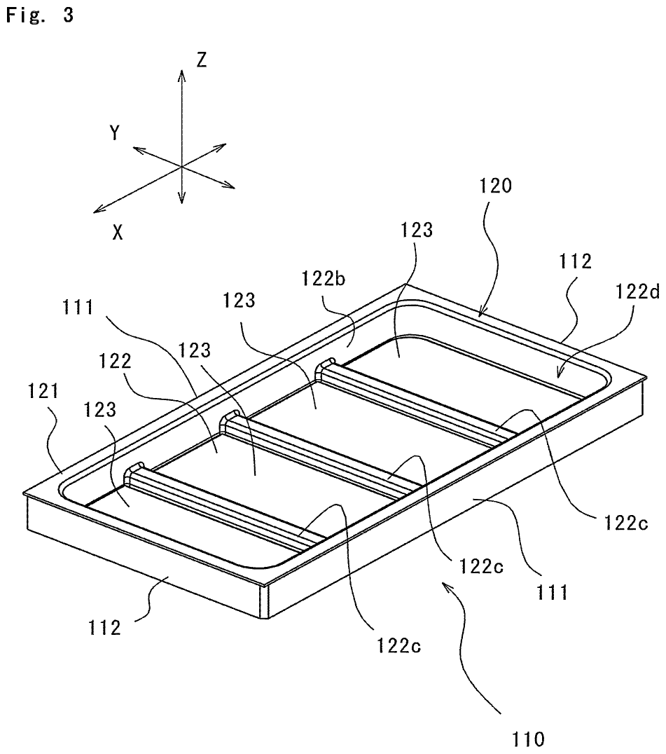

Referring to FIG. 3 again, in a state where the tray 120 and the frame 110 are combined, the flange 121 of the tray 120 is placed on the upper surface of the frame 110, and the housing portion 122 of the tray 120 is disposed in the through hole TH of the frame 110. At this time, the projecting portion 122c is disposed so as to partially cover the cross member 113. Although an exploded view is virtually shown in FIG. 4 for the sake of illustration, the tray 120 is integrated in a combined state as shown in FIG. 3 by being brought into pressure contact with the frame 110 and the three cross members 113.

Referring to FIG. 2 again, the battery 30 is disposed in the housing portion 122 of the tray 120. Hermetically sealing the housing portion 122 with the top cover 130 from above the battery 30 houses the battery 30 in the battery case 100. The hermetic sealing structure prevents water from entering the battery case 100 from the outside. In particular, since the tray 120 is formed in a bathtub shape, there is no joint in the tray 120, and high sealing performance capable of preventing water from entering from a road surface or the like can be secured. In addition, a safety valve for pressure adjustment inside the battery case 100 may be provided.

In the example in FIG. 2, the top cover 130 and the tray 120 are fastened and fixed to the frame 110 by screws. Above the top cover 130, a floor panel 300 constituting a floor surface of the vehicle interior R and a floor cross member 400 extending in the vehicle width direction in the vehicle interior R are disposed. In addition, an under cover 140 is disposed below the tray 120. The under cover 140 is screwed to each of the frame 110 and the cross member 113 to support the tray 120 from below.

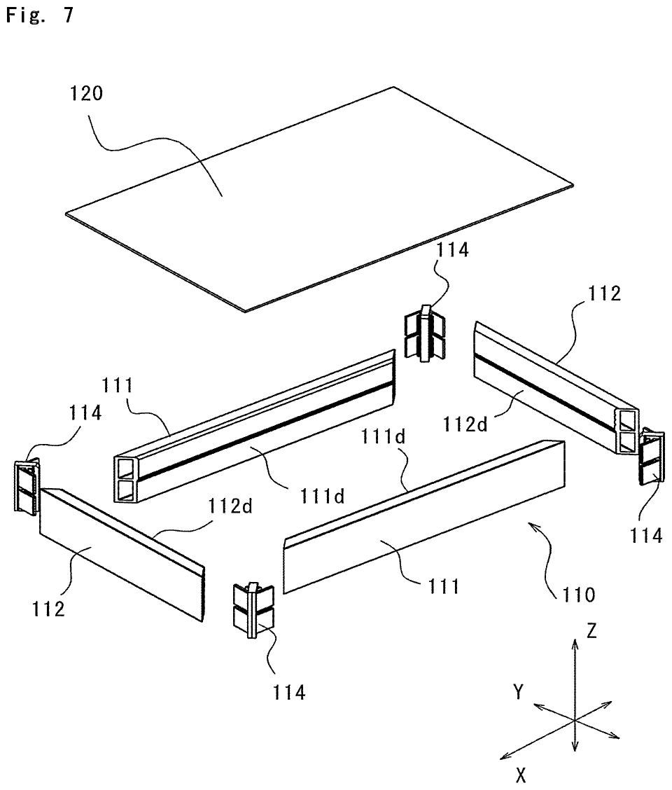

A method for manufacturing the battery case 100 having the above configuration will be described with reference to FIGS. 7 to 11.

Referring to FIG. 7, a flat plate-shaped member to be formed 120, a first framework member 111, a second framework member 112, and a joining member 114 are prepared. Then, the first framework member 111 and the second framework member 112 are joined through the joining member 114 to constitute a frame 110 having a rectangular frame shape when viewed from the vehicle vertical direction and defining the through hole TH inside (see FIG. 4).

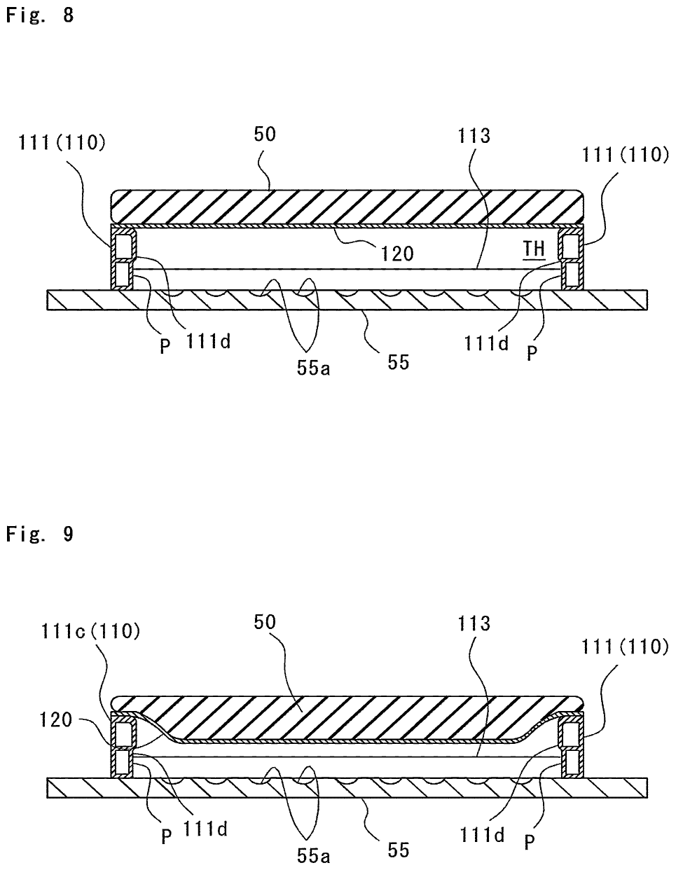

Referring to FIG. 8, the member to be formed 120 is superposed on the frame 110 to be disposed on the table 55. A recessed portion 55a having a shape corresponding to the groove 124 is formed on the upper surface of the table 55 in order to form the groove 124 in the tray 120 as described below. It should be noted that the same reference numeral 120 is used for the member to be formed and the tray, which means that the state before forming is the member to be formed and the state after forming is the tray.

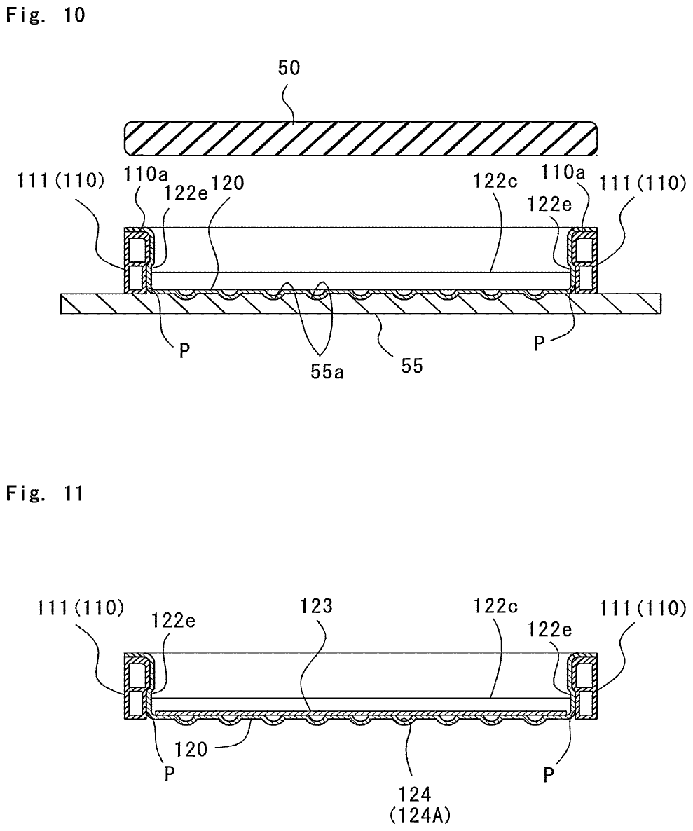

Next, with reference to FIGS. 9 and 10, pressure is applied to the member to be formed 120 from the side opposite to that of the frame 110 (that is, the upper side), and the member to be formed 120 is pressed against the frame 110 to swell in the through hole TH, thereby deforming the member to be formed 120 into a bathtub-shaped tray 120 and bringing the member to be formed 120 into pressure contact with the frame 110. At this time, the member to be formed 120 is also brought into pressure contact with the three cross members 113. As a result, the tray 120, the frame 110, and the three cross members 113 are integrated.

In the present embodiment, the pressurization against the member to be formed 120 is performed by a pressure forming method (rubber bulging method) using an elastic body. The pressure forming method refers to a method of forming a member by gas or liquid pressure. In the present embodiment, in the rubber bulging method, the hydraulic transfer elastic body 50 that is elastically deformable using the pressure of the liquid is used. The hydraulic transfer elastic body 50 may have a structure in which only a lower surface of a metal chamber containing a liquid such as water or oil is closed with an elastic film, for example. In such a hydraulic transfer elastic body 50, the elastic film is deformed by adjusting the pressure of the liquid, and forming can be performed without the liquid coming into direct contact with the member to be formed 120.

Referring to FIGS. 8 and 9, in the present embodiment, the frame 110, the member to be formed 120, and the hydraulic transfer elastic body 50 are superposed and disposed in this order on the table 55, and the member to be formed 120 is pressurized and pressed against the frame 110 through the hydraulic transfer elastic body 50. Preferably, pressurization of the member to be formed 120 by the rubber bulging method is performed in a state where the member to be formed 120 is heated and softened. In this case, due to the softening of the member to be formed 120, cracking during forming of the tray 120 can be suppressed.

In addition, on the upper surface of the table 55, a recessed portion 55a having a shape corresponding to the groove 124 is formed so that the groove 124 can be formed in the tray 120. Therefore, a groove 124 (see FIG. 5) is formed on the bottom wall 122a of the tray 120 along with the pressurization by the hydraulic transfer elastic body 50. That is, in the present embodiment, the member to be formed 120 is formed into the tray 120 having a bathtub shape, and the groove 124 is formed on the bottom wall 122a of the housing portion 122 of the tray 120. Although not shown in detail, in addition to the forming of the groove 124, a protrusion for positioning the battery 30 may be formed on the tray 120.

Referring to FIG. 10, when the pressurizing force is released after the member to be formed 120 is deformed into the bathtub-shaped tray 120, the hydraulic transfer elastic body 50 is restored to a shape in the natural state. Therefore, the hydraulic transfer elastic body 50 can be easily removed from the inside of the tray 120. After the hydraulic transfer elastic body 50 is removed, as shown in FIG. 2, the closing plate 123 and the under cover 140 are joined to house the battery 30, and then the top cover 130 is joined to form a battery pack. It should be noted that here, a container that houses the battery 30 is referred to as a battery case 100, and an object that is brought into a state of functioning by housing the battery 30 and a control apparatus in the battery case 100 is referred to as a battery pack.

In the present embodiment, in the frame 110, the wall thickness of the upper portion 110a is set to be larger than that of another portion. The upper portion 110a of the frame 110 is a portion susceptible to force due to the forming described above, and increasing the wall thickness of the portion prevents unintended deformation. In addition, an R shape (rounded shape) is imparted to the inner side of the upper portion 110a of the frame 110. The R shape prompts the material to flow into the member to be formed 120 in the forming. However, in view of the design of the extruded material or the like, a small R shape may be formed on a portion in addition to the inner side of the upper portion 110a of the frame 110. In the drawings, let such a small R shape be omitted.

In the present embodiment, when the member to be formed 120 is formed into the bathtub-shaped tray 120, negative angle forming is performed. Here, the negative angle is a term often used in the forming field using a die, and indicates that the die draft angle in the formed member is less than zero (negative). In the present embodiment, the tray 120 is pressed against the step surfaces 111d and 112d of the frame 110 by pressurization from the hydraulic transfer elastic body 50, and the tray 120 is provided with a negative angle portion 122e in which a negative angle directed upward in the vehicle vertical direction from the bottom wall 122a of the tray 120 toward the inside in the horizontal direction is formed. In other words, the negative angle portion 122e is configured to enter the recessed portion P configured by the step surfaces 111d and 112d. In addition, such a recessed portion P may also be provided in the three cross members 113. Thus, by providing the recessed portion P in the frame 110, it is possible to easily and reliably execute the negative angle forming that forms the negative angle portion 122e in the tray 120.

Next, referring to FIG. 11, the closing plate 123 is disposed and joined to the bottom wall 122a of the tray 120 so as to close the groove 124 formed as described above. The closing plate 123 is disposed on the housing portion 122 of the tray 120 from above, and is joined by, for example, an FSW. In this manner, the closing plate 123 and the groove 124 define a coolant flow path 124A through which a coolant flows.

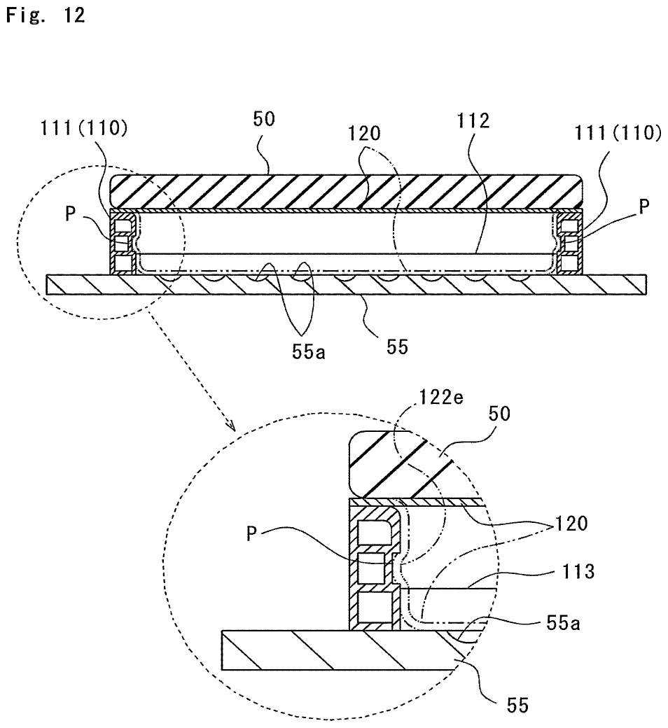

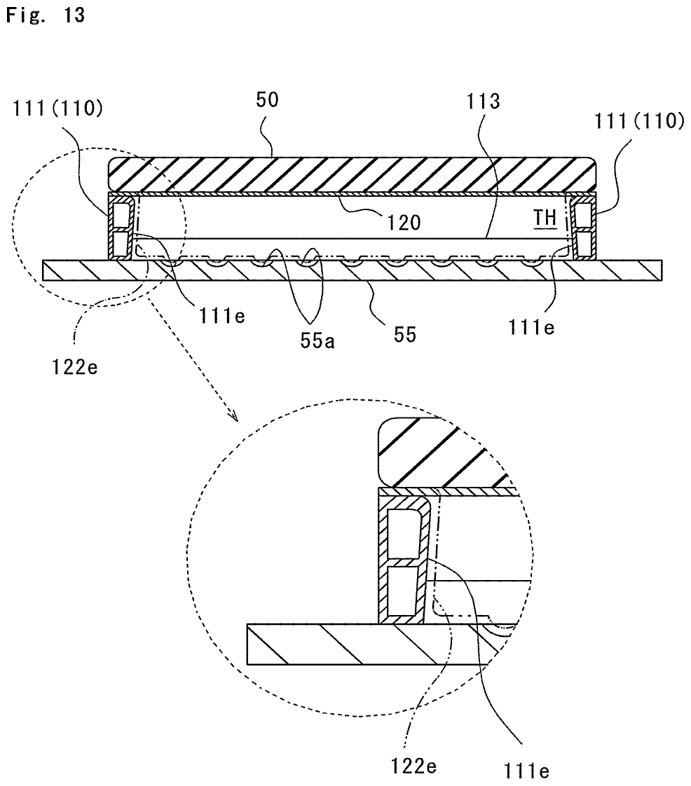

In addition, modifications of the negative angle forming are shown in FIGS. 12 and 13. In the example in FIG. 12, the recessed portion P is provided at the central portion in the vehicle vertical direction of the step surface 111d inside the frame 110. In the example in FIG. 13, an inclined surface 111e is provided instead of the step surface 111d. That is, the inclined surface 111e inside the frame 110 is provided to be inclined so as to narrow the through hole TH as it goes upward.

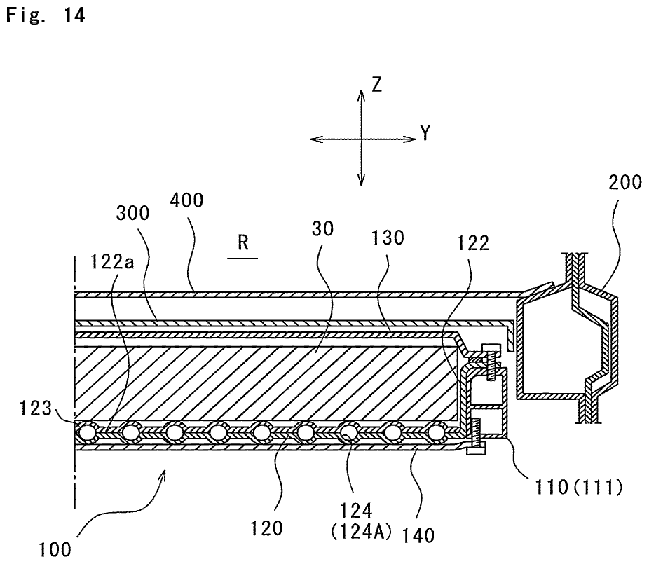

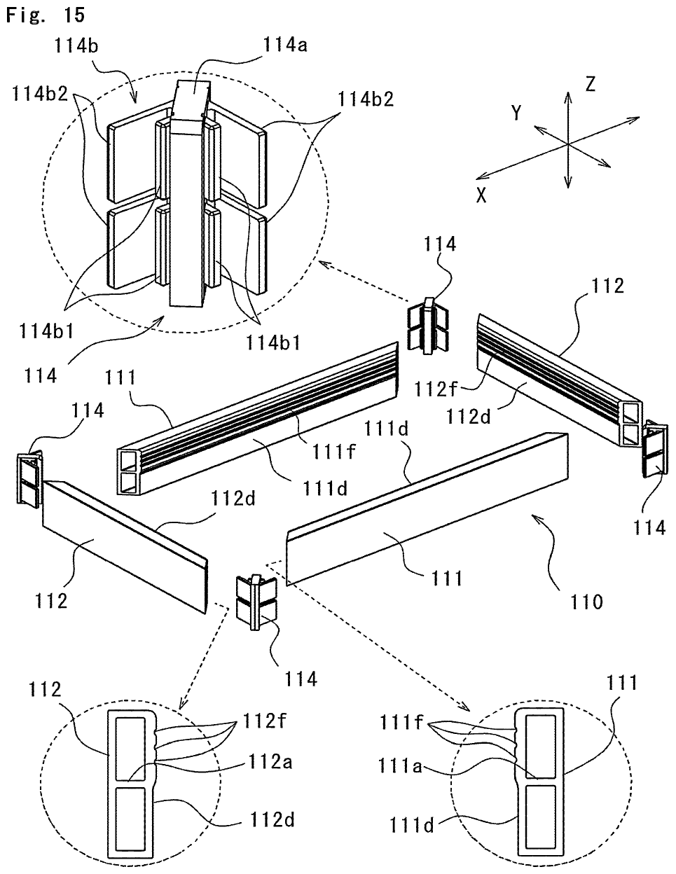

In addition, as a modification of the closing plate 123, an uneven shape may be imparted to the closing plate 123 as shown in FIG. 14. In the configuration described above, the closing plate 123 having a flat surface is exemplified, but an upward protruding shape (downward recessed shape) may be imparted to the closing plate 123 in accordance with the shape of the groove 124 so as to enlarge the flow path area of the coolant flow path 124A. In the example in FIG. 14, a semicircular shape vertically symmetrical with respect to the semicircular shape of the groove 124 is imparted to the closing plate 123. In this way, by enlarging the flow path area of the coolant flow path 124A, the flow rate of the coolant can be increased, and the cooling performance can be improved.

According to the battery case 100 and the method for manufacturing the same as described above, the following actions and effects are produced.

Since the first framework member 111 and the second framework member 112 are indirectly joined through the joining member 114 by the mechanical joining method, complicated welding is not required. Therefore, thermal damage to the frame 110 can be suppressed, and the frame 110 can be simply configured. Furthermore, since the first framework member 111 and the second framework member 112 are joined through the joining member 114, it is possible to prevent the joint portion from being deformed by an external force and to improve the rigidity of the entire battery case 100. In addition, since the tray 120 is formed in a bathtub shape, there is no joint in the tray 120, and high sealing performance capable of preventing water from entering from a road surface or the like can be secured.

In addition, since the frame 110 and the tray 120 are brought into pressure contact with each other, the frame 110 and the tray 120 can be easily integrated without requiring welding. At this time, the manufacturing step can be simplified by simultaneously performing the forming of the bathtub-shaped tray and the pressure contact between the tray and the frame.

In addition, even when an upward force is applied to the tray 120, the negative angle portion 122e is caught by the frame 110, so that the tray 120 can be prevented from being detached from the frame 110. That is, the pressure contact between the tray 120 and the frame 110 can be prevented from being released.

It should be noted that the shape of the frame 110 is not limited to that of the above embodiment. For example, as shown in FIG. 15, a plurality of grooves 111f may be formed in the upper portion of the step surface 111d of the first framework member 111. Similarly, a plurality of grooves 112f may be formed in the upper portion of the step surface 112d of the second framework member 112. The plurality of grooves 111f and 112f may further strengthen the pressure contact between the frame 110 and the tray 120.

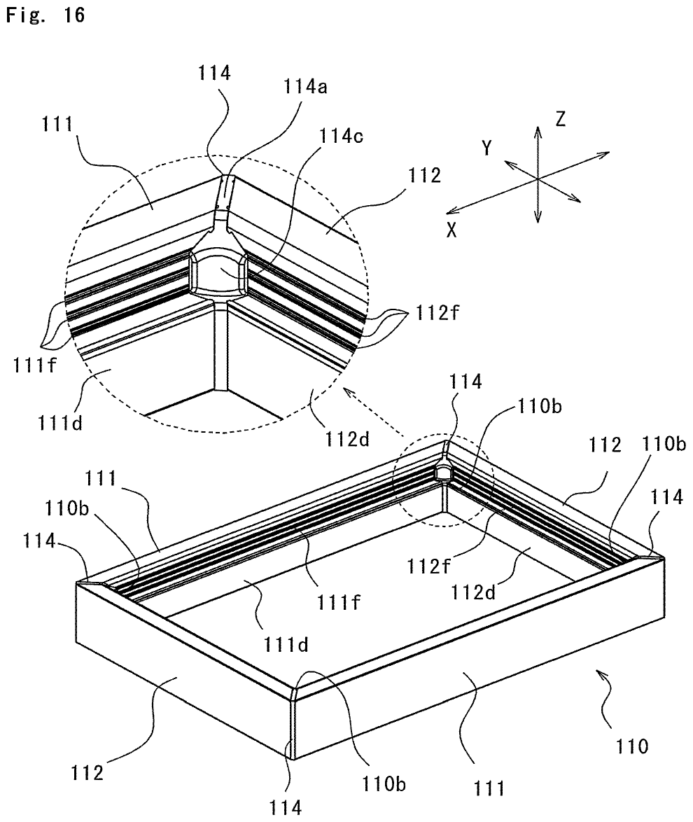

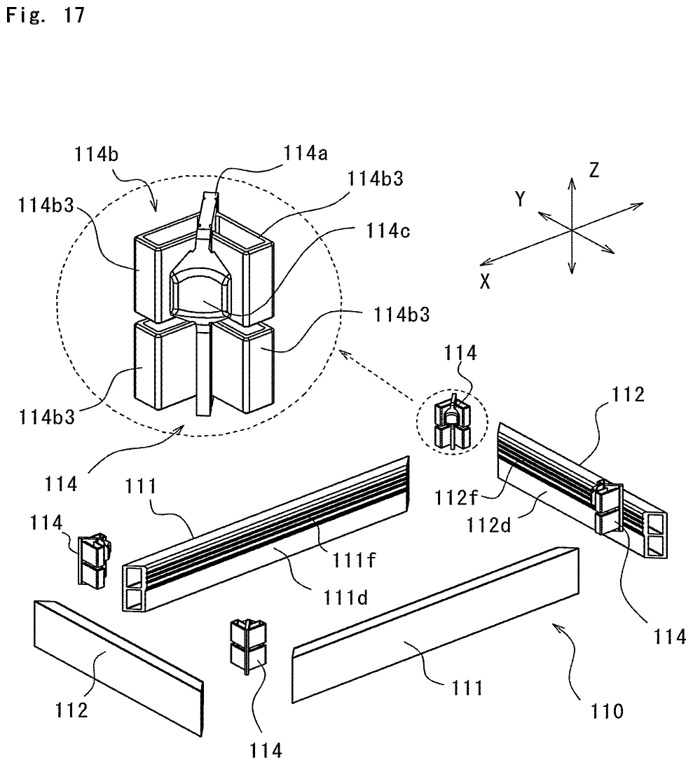

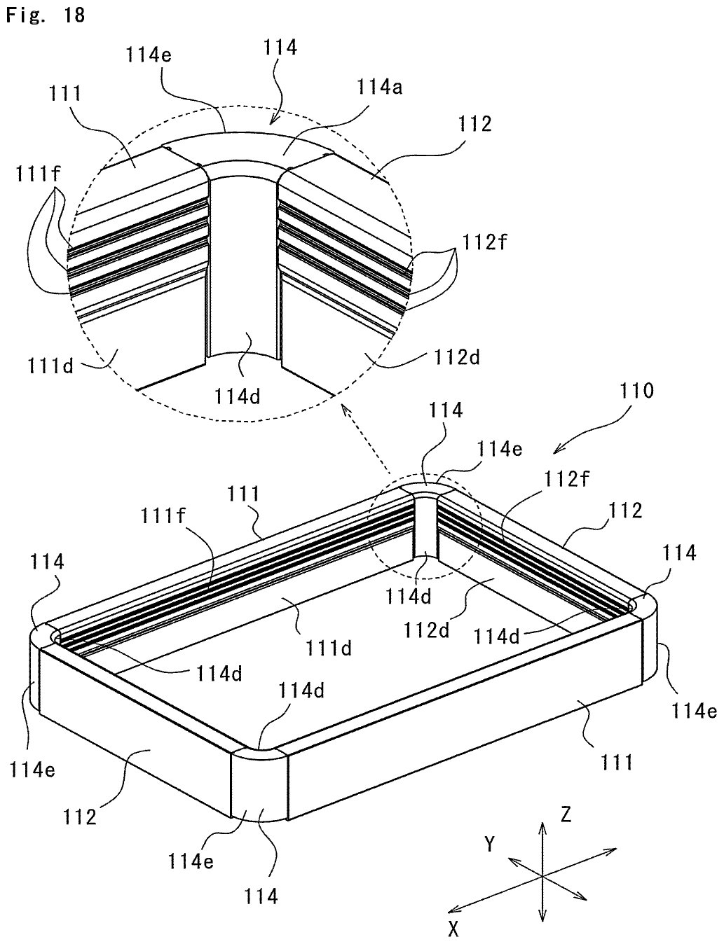

In addition, the shape of the joining member is not limited to that of the above embodiment. For example, as shown in FIGS. 16 and 17, the protruding portion 114b may have four protruding pieces 114b3 having a substantially U shape when viewed from the vehicle vertical direction. In addition, the joining member 114 may have a curved surface 114c that forms the inner corner portion 110b of the frame 110 into a curved shape when viewed from the vehicle vertical direction. The curved surface 114c smoothly connects the step surface 111d of the first framework member 111 and the step surface 112d of the second framework member 112. For example, the curved surface 114c may have a circular arc shape when viewed from the vehicle vertical direction.

In addition, since the curved surface 114c has a shape bulging toward the inside of the frame 110 when viewed from the vehicle vertical direction, it is possible to perform the negative angle forming of the tray 120 as described above by forming the curved surface 114c on the upper portion of the base portion 114a. Accordingly, at the time of pressure contact, the tray 120 is pressed against the curved surface 114c at the inner corner portion 110b of the frame 110. If the inner corner portion 110b is at a right angle, there is a risk that the corner portion of the tray 120 tends to be deformed into a right angle, and stress is concentrated thereon to cause cracking. However, since the inner corner portion 110b is the curved surface 114c, the corner portion of the tray 120 is supported by the curved surface 114c at the time of pressure contact, so that it is possible to suppress the concentration of stress on the corner portion of the tray 120 and to suppress the cracking of the tray 120.

### Second Embodiment

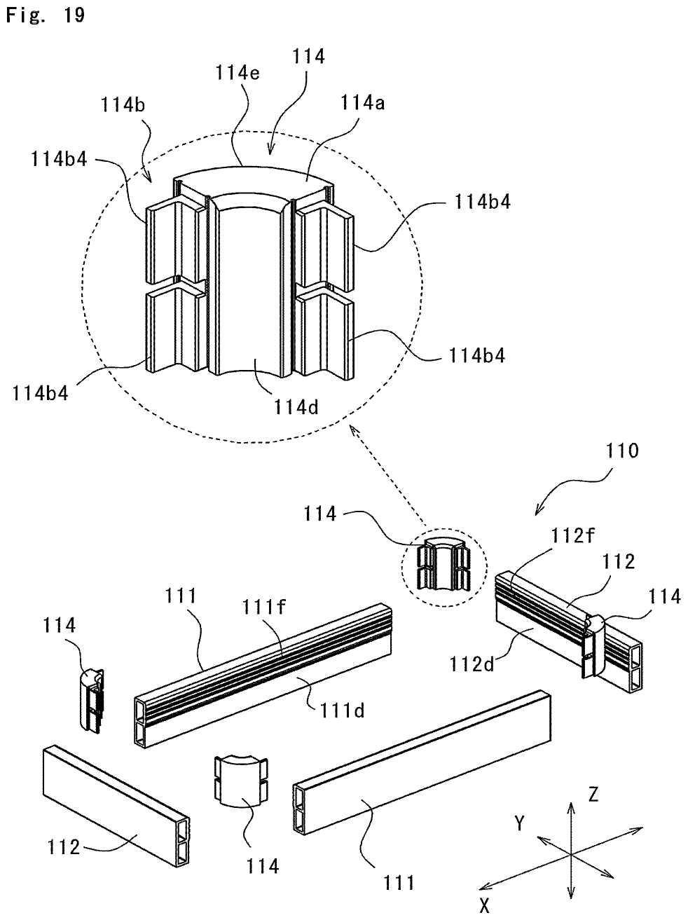

The second embodiment shown in FIGS. 18 and 19 is different from the first embodiment in the configuration related to the first framework member 111, the second framework member 112, and the joining member 114. Those other than the configurations related to these are substantially the same as those of the first embodiment and the modification thereof. Therefore, a description of the portions shown in the first embodiment and the modification thereof may be omitted.

In the present embodiment, both end portions in the vehicle front-rear direction of the first framework member 111 are cut perpendicular to the vehicle front-rear direction. Similarly, both end portions in the vehicle width direction of the second framework member 112 are cut perpendicular to the vehicle width direction. Therefore, the first framework member 111 and the second framework member 112 can be easily manufactured as compared with those of the first embodiment.

In the joining member 114 of the present embodiment, the base portion 114a has an annular fan-shaped columnar shape. In the base portion 114a, a surface positioned on the inner side and a surface positioned on the outer side of the frame 110 are curved surfaces 114d and 114e, respectively. Therefore, when viewed from the vehicle vertical direction, the inner shape and the outer shape of the frame 110 are corner-rounded quadrangles. In addition, the protruding portion 114b has four protruding pieces 114b4. The joining member 114 is joined to the first framework member 111 and the second framework member 112 at the four protruding pieces 114b4 by the mechanical joining method.

The method for manufacturing the battery case 100 of the present embodiment is substantially the same as that of the first embodiment.

The actions and effects of the battery case 100 having the above-described configuration and the method for manufacturing the same are also substantially the same as those of the first embodiment.

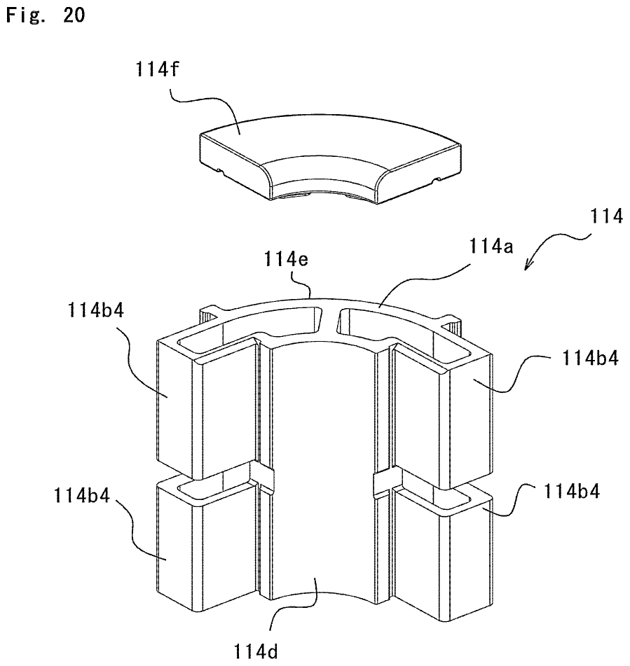

Referring to FIG. 20, a first modification of the joining member 114 will be described.

In a joining member 114 of the first modification shown in FIG. 20, an upper cover 114f is provided with respect to that of the second embodiment. Each of the four protruding pieces 114b4 has a substantially U shape when viewed from the vehicle vertical direction.

According to the present modification, the degree of freedom in designing the joining member 114 can be improved, and the reduction in wall thickness and weight can be easily implemented. In addition, when the joining member 114 is formed of an extruded material, since a product shape can be easily formed only by cutting only a portion corresponding to the partition wall 111a from the extruded shape, the amount of cutting work can be reduced.

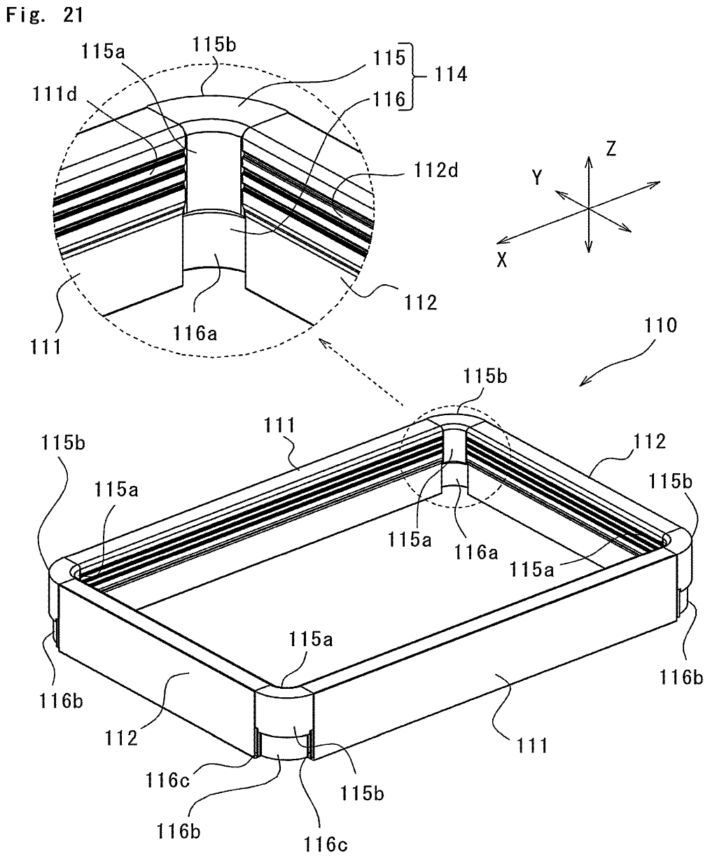

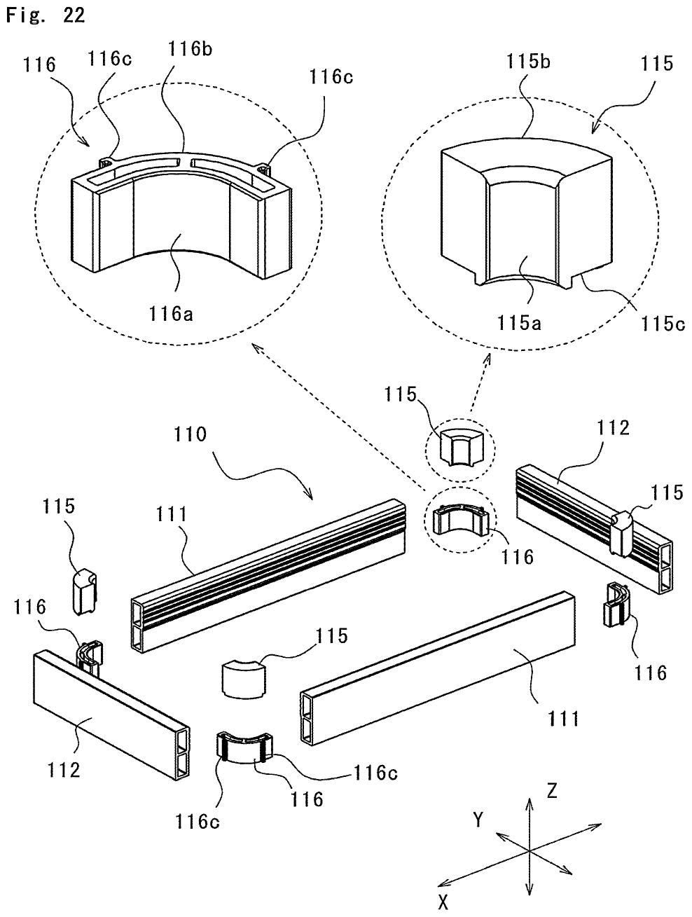

In addition, referring to FIGS. 21 and 22, a second modification of the joining member 114 will be described.

In the second modification shown in FIGS. 21 and 22, the joining member 114 includes an upper member 115 and a lower member 116 disposed on the lower side of the upper member 115.

Both the upper member 115 and the lower member 116 have substantially annular fan-shaped columnar shapes. Therefore, in the upper member 115, a surface positioned on the inner side and a surface positioned on the outer side of the frame 110 are curved surfaces 115a and 115b, respectively. Similarly, also in the lower member 116, a surface positioned on the inner side and a surface positioned on the outer side of the frame 110 are curved surfaces 116a and 116b, respectively. In particular, the curved surface 115a of the upper member 115 smoothly connects the step surface 111d of the first framework member 111 and the step surface 112d of the second framework member 112. In addition, a projection portion 116c for positioning the upper member 115 is formed on the curved surface 116b of the lower member 116.

On the lower surface of the upper member 115, a recessed portion 115c having a shape complementary to that of the lower member 116 is provided. By disposing the lower member 116 in the recessed portion 115c, the upper member 115 and the lower member 116 are fitted. In the fitted state, the curved surface 115a of the upper member 115 is positioned further inside the frame 110 than the curved surface 116a of the lower member. Therefore, the negative angle forming described above can be performed.

In the present modification, the upper member 115 is not either inserted into or joined to the first framework member 111 and the second framework member 112. The lower member 116 is inserted into the first framework member 111 and the second framework member 112 at both end portions, and is joined to these by a mechanical joining method. Therefore, the upper member 115 is fixed in position by being fitted to the lower member 116 at the recessed portion 115c.

According to the present modification, since the joining member 114 is vertically divided, the degree of freedom in design when manufacturing the joining member 114 is improved.

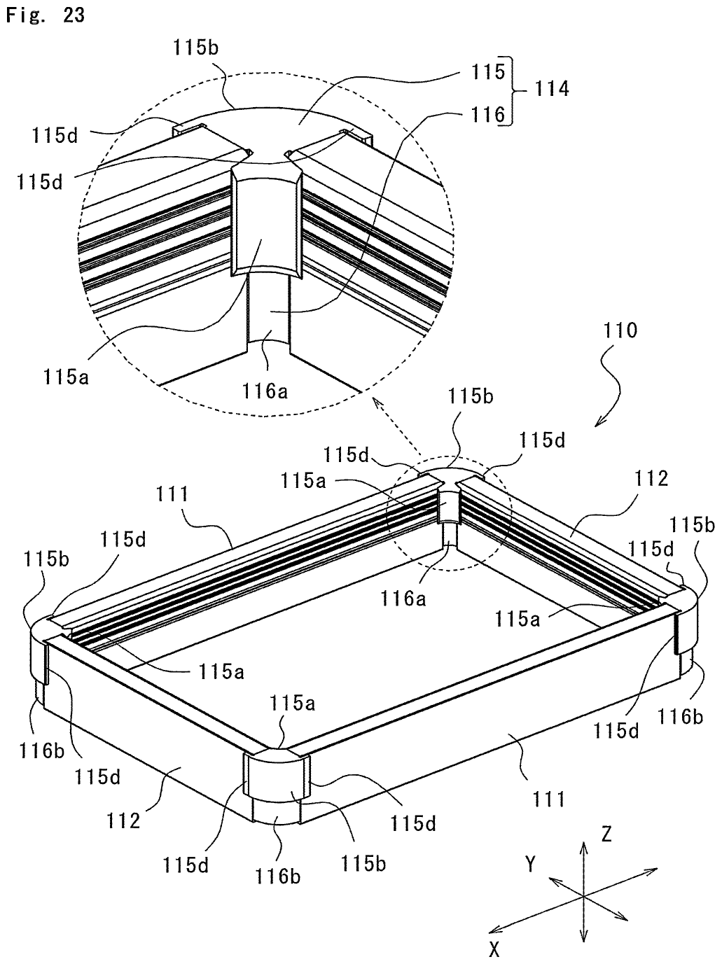

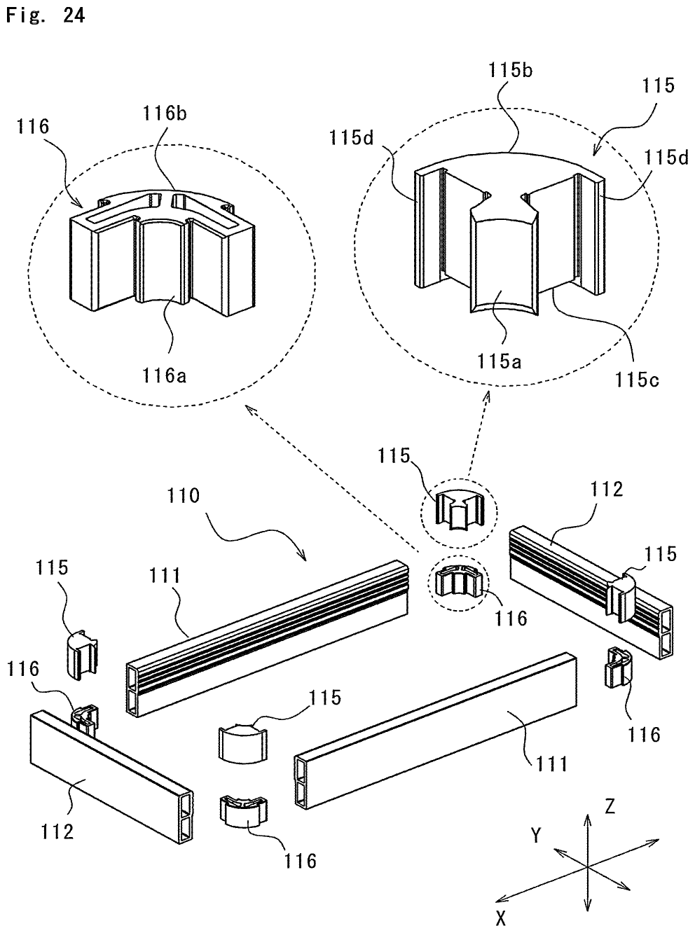

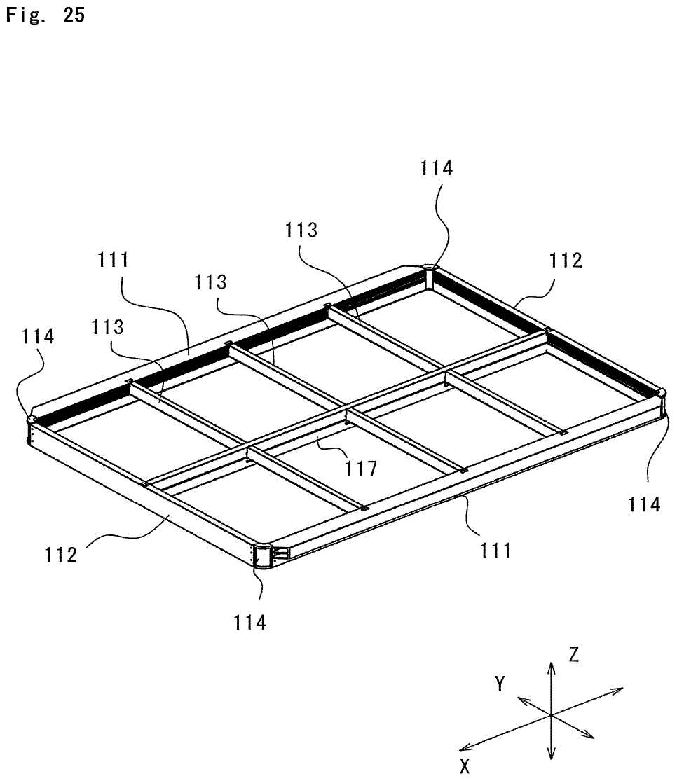

In addition, referring to FIGS. 23 and 24, a third modification of the joining member 114 will be described.

In the third modification shown in FIGS. 23 and 24, similarly to the second modification, the joining member 114 includes an upper member 115 and a lower member 116. In addition, the upper member 115 and the lower member 116 further include the following in addition to the configuration of the second modification.

The upper member 115 includes a flange portion 115d that supports each of the outer surfaces of the first framework member 111 and the second framework member 112 constituting the outer surface of the frame 110 when viewed from the vehicle vertical direction. In addition, the upper member 115 is configured so that the curved surface 115a protrudes to the inside of the frame 110. That is, the curved surface 115a does not smoothly connect the step surface 111d of the first framework member 111 and the step surface 112d of the second framework member 112 as in the second modification, but is positioned inside the frame 110 as compared with them. Therefore, the portion constituting the curved surface 115a and the flange portion 115d are configured to hold the end portion of the first framework member 111 and the end portion of the second framework member 112. In other words, unlike the second modification, the upper member 115 has a shape fitted to the first framework member 111 and the second framework member 112.

Similarly to the upper member 115, the lower member 116 is configured so that the curved surface 116a protrudes to the inside of the frame 110. However, since the curved surface 115a of the upper member 115 is positioned further inside the frame 110 than the curved surface 116a of the lower member 116, negative angle forming can be performed at this portion.

Also in the present modification, the upper member 115 is not inserted into the first framework member 111 and the second framework member 112, but is fitted to these. Therefore, the upper member 115 is fixed in position by being fitted to the first framework member 111, the second framework member 112, and the lower member 116. It should be noted that as in the second modification, the lower member 116 is inserted into the first framework member 111 and the second framework member 112 at both end portions, and is joined to these by a mechanical joining method.

According to the present modification, since the first framework member 111 and the second framework member 112 are supported by the flange portion 115d, deformation of the joint portion can be suppressed.

In addition, referring to FIG. 25, a cross member 117 extending in the vehicle front-rear direction may be provided for the frame 110 and the three cross members 113 in the first and second embodiments.

The cross member 117 is arranged in parallel with the two first framework members 111 so as to connect the two second framework members 112 in the through hole TH. The cross member 117 is disposed orthogonal to the three cross members 113, and has a function of improving the strength of the battery case 100. In particular, joining to the three cross members 113 can improve strength against collision from the front-rear direction of the electric vehicle 1 (see FIG. 1). It should be noted that the mode of the cross member 117 is not particularly limited, and the size, shape, arrangement, number, and the like thereof can be optionally set. In addition, the cross member 117 is not an essential configuration and may be omitted as necessary.

As described above, although the specific embodiments and their modifications of the present disclosure are described, the present disclosure is not limited to the above-described embodiments, and can be implemented with various modifications within the scope of the present invention. For example, an appropriate combination of contents of the individual embodiments and modifications may be one embodiment of the present invention.

The present disclosure may include the following aspects.

### Aspect 1

An electric vehicle battery case including:
a frame including a plurality of framework members joined through a joining member, the frame formed in a polygonal frame shape when viewed from a vehicle vertical direction, the frame configured to define a space inside; and
a tray having a bathtub shape configured to house a battery, the tray disposed at least partially in the space of the frame, wherein
the plurality of framework members includes a first framework member and a second framework member which are made of an aluminum extruded material, and
in the frame, the first framework member and the joining member are joined by a mechanical joining method, and the second framework member and the joining member are joined by a mechanical joining method, which leads to the first framework member and the second framework member being indirectly joined through the joining member.

### Aspect 2

The electric vehicle battery case according to aspect 1, wherein the mechanical joining method includes flow drill screw joining.

### Aspect 3

The electric vehicle battery case according to aspect 1 or 2, wherein the tray is brought into pressure contact with the frame.

### Aspect 4

The electric vehicle battery case according to aspect 3, wherein a negative angle portion in which a negative angle directed at least partially inward in a horizontal direction from a bottom wall of the tray toward an upper side in the vehicle vertical direction is formed is provided.

### Aspect 5

The electric vehicle battery case according to aspect 3 or 4, wherein the joining member has a curved surface that forms an inner corner portion of the frame into a curved shape when viewed from the vehicle vertical direction.

### Aspect 6

The electric vehicle battery case according to any one of aspects 1 to 5, wherein
the joining member includes an upper member disposed at a relatively upper position and a lower member disposed at a relatively lower position in the vehicle vertical direction,
the lower member is joined to the first framework member and the second framework member by the mechanical joining method, and
the upper member is fitted and fixed to the lower member.

### Aspect 7

The electric vehicle battery case according to aspect 6, wherein the upper member includes a flange portion that supports each of outer surfaces of the first framework member and the second framework member constituting an outer surface of the frame when viewed from the vehicle vertical direction.

### Aspect 8

A method for manufacturing an electric vehicle battery case, the method including:
preparing a member to be formed having a flat-plate shape, a plurality of framework members, and a joining member, the plurality of framework members including a first framework member and a second framework member which are made of an aluminum extruded material;
indirectly joining the first framework member and the second framework member through the joining member by joining the first framework member and the joining member by a mechanical joining method and by joining the second framework member and the joining member by a mechanical joining method to form a frame having a polygonal frame shape when viewed from a vehicle vertical direction and defining a space inside;
superposing and disposing the member to be formed on the frame; and
applying pressure to the member to be formed from a side opposite to that of the frame, pressing the member to be formed against the frame, swelling the member to be formed in the space, resulting in deforming the member to be formed into a tray having a bathtub shape and bringing the member to be formed into pressure contact with the frame.

This application claims priority based on Japanese Patent Application No. 2022-036045 filed on Mar. 9, 2022. Japanese Patent Application No. 2022-036045 is incorporated herein by reference.

### EXPLANATION OF REFERENCES

1 electric vehicle
10 vehicle body front portion
20 vehicle body central portion
30 battery
50 hydraulic transfer elastic body
55 table
55a recessed portion
100 electric vehicle battery case (battery case)
110 frame
110a upper portion
110b inner corner portion
111 first framework member (framework member)
111a partition wall
111d step surface
111e Inclined surface
111f groove
112 second framework member (framework member)
112a partition wall
112d step surface
112f groove
113 cross member
114 joining member
114a base portion
114b protruding portion
114b1 inner protruding piece
114b2 outer protruding piece
114b3, 114b4 protruding piece
114c, 114d, 114e curved surface
114f upper cover
115 upper member
115a, 115b curved surface
115c recessed portion
115d flange portion
116 lower member
116a, 116b curved surface
116c projection portion
117 cross member
120 tray (member to be formed)
121 flange
122 housing portion
122a bottom wall
122b peripheral wall
122b1 corner portion
122c projecting portion
122d opening
122e negative angle portion
123 closing plate
124 groove
124a Inlet
124A coolant flow path
124b outlet
130 top cover
140 under cover
200 rocker member
300 floor panel
400 floor cross member
P recessed portion

1. An electric vehicle battery case comprising:
a frame including a plurality of framework members joined through a joining member, the frame formed in a polygonal frame shape when viewed from a vehicle vertical direction, the frame configured to define a space inside; and
a tray having a bathtub shape configured to house a battery, the tray disposed at least partially in the space of the frame, wherein
the plurality of framework members includes a first framework member and a second framework member which are made of an aluminum extruded material, and
in the frame, the first framework member and the joining member are joined by a mechanical joining method, and the second framework member and the joining member are joined by a mechanical joining method, which leads to the first framework member and the second framework member being indirectly joined through the joining member.

2. The electric vehicle battery case according to claim 1, wherein the mechanical joining method includes flow drill screw joining.

3. The electric vehicle battery case according to claim 1, wherein the tray is brought into pressure contact with the frame.

4. The electric vehicle battery case according to claim 2, wherein the tray is brought into pressure contact with the frame.

5. The electric vehicle battery case according to claim 3, wherein a negative angle portion in which a negative angle directed at least partially inward in a horizontal direction from a bottom wall of the tray toward an upper side in the vehicle vertical direction is formed is provided.

6. The electric vehicle battery case according to claim 4, wherein a negative angle portion in which a negative angle directed at least partially inward in a horizontal direction from a bottom wall of the tray toward an upper side in the vehicle vertical direction is formed is provided.

7. The electric vehicle battery case according to claim 3, wherein the joining member has a curved surface that forms an inner corner portion of the frame into a curved shape when viewed from the vehicle vertical direction.

8. The electric vehicle battery case according to claim 1, wherein
the joining member includes an upper member disposed at a relatively upper position and a lower member disposed at a relatively lower position in the vehicle vertical direction,
the lower member is joined to the first framework member and the second framework member by the mechanical joining method, and
the upper member is fitted and fixed to the lower member.

9. The electric vehicle battery case according to claim 7, wherein
the joining member includes an upper member disposed at a relatively upper position and a lower member disposed at a relatively lower position in the vehicle vertical direction,
the lower member is joined to the first framework member and the second framework member by the mechanical joining method, and
the upper member is fitted and fixed to the lower member.

10. The electric vehicle battery case according to claim 8, wherein the upper member includes a flange portion that supports each of outer surfaces of the first framework member and the second framework member constituting an outer surface of the frame when viewed from the vehicle vertical direction.

11. The electric vehicle battery case according to claim 9, wherein the upper member includes a flange portion that supports each of outer surfaces of the first framework member and the second framework member constituting an outer surface of the frame when viewed from the vehicle vertical direction.

12. A method for manufacturing an electric vehicle battery case, the method comprising:
preparing a member to be formed having a flat-plate shape, a plurality of framework members, and a joining member, the plurality of framework members including a first framework member and a second framework member which are made of an aluminum extruded material;
indirectly joining the first framework member and the second framework member through the joining member by joining the first framework member and the joining member by a mechanical joining method and by joining the second framework member and the joining member by a mechanical joining method to form a frame having a polygonal frame shape when viewed from a vehicle vertical direction and defining a space inside;
superposing and disposing the member to be formed on the frame; and
applying pressure to the member to be formed from a side opposite to that of the frame, pressing the member to be formed against the frame, swelling the member to be formed in the space, resulting in deforming the member to be formed into a tray having a bathtub shape and bringing the member to be formed into pressure contact with the frame.

13. The electric vehicle battery case according to claim 5, wherein the joining member has a curved surface that forms an inner corner portion of the frame into a curved shape when viewed from the vehicle vertical direction.

14. The electric vehicle battery case according to claim 2, wherein
the joining member includes an upper member disposed at a relatively upper position and a lower member disposed at a relatively lower position in the vehicle vertical direction,
the lower member is joined to the first framework member and the second framework member by the mechanical joining method, and
the upper member is fitted and fixed to the lower member.

15. The electric vehicle battery case according to claim 3, wherein
the joining member includes an upper member disposed at a relatively upper position and a lower member disposed at a relatively lower position in the vehicle vertical direction,
the lower member is joined to the first framework member and the second framework member by the mechanical joining method, and
the upper member is fitted and fixed to the lower member.

16. The electric vehicle battery case according to claim 5, wherein
the joining member includes an upper member disposed at a relatively upper position and a lower member disposed at a relatively lower position in the vehicle vertical direction,
the lower member is joined to the first framework member and the second framework member by the mechanical joining method, and
the upper member is fitted and fixed to the lower member.

17. The electric vehicle battery case according to claim 13, wherein
the joining member includes an upper member disposed at a relatively upper position and a lower member disposed at a relatively lower position in the vehicle vertical direction,
the lower member is joined to the first framework member and the second framework member by the mechanical joining method, and
the upper member is fitted and fixed to the lower member.

18. The electric vehicle battery case according to claim 14, wherein the upper member includes a flange portion that supports each of outer surfaces of the first framework member and the second framework member constituting an outer surface of the frame when viewed from the vehicle vertical direction.

19. The electric vehicle battery case according to claim 15, wherein the upper member includes a flange portion that supports each of outer surfaces of the first framework member and the second framework member constituting an outer surface of the frame when viewed from the vehicle vertical direction.

20. The electric vehicle battery case according to claim 16, wherein the upper member includes a flange portion that supports each of outer surfaces of the first framework member and the second framework member constituting an outer surface of the frame when viewed from the vehicle vertical direction.
